(19) United States
(12) Patent Application Publication
(10) Pub. No.: US 2024/0410711 A1
(43) Pub. Date: Dec. 12, 2024

(54) Augmented Reality Street Annotations

(71) Applicant: GOOGLE LLC, Mountain View, CA (US)

(72) Inventors: Juan David Hincapie, Mountain View, CA (US); Mohamed Suhail Mohamed Yousuf sait, Mountain View, CA (US); Marek Gorecki, Mountain View, CA (US); Andre Le, Mountain View, CA (US); Michael Humphrey, Mountain View, CA (US); Devin Nickoloff, Mountain View, CA (US); Mirko Ranieri, Mountain View, CA (US); Loran Briggs, Mountain View, CA (US); Yan Wang, Mountain View, CA (US); Carlos David Correa Ocampo, Mountain View, CA (US); Wenli Zhao, Mountain View, CA (US)

(21) Appl. No.: 18/697,214

(22) PCT Filed: Sep. 29, 2021
(86) PCT No.: PCT/US21/52649

§ 371 Date: Mar. 29, 2024

(51) Int. Cl. G01C 21/36; G06T 15/20; G06T 19/00

(52) U.S. Cl. CPC G01C 21/3673; G01C 21/365; G06T 15/20; G06T 19/006; G06T 2210/21; G06T 2210/32; G06T 2219/004

(57) ABSTRACT

Systems, methods, and and/or algorithms facilitate navigation with augmented reality by determining which streets should be annotated, and/or determining the position and/or format of street annotations, based on factors such as user distance and orientation relative to streets, and/or the configuration of streets (e.g., whether nearby streets form a simple intersection, a complex intersection, or no intersection).

### FIELD OF TECHNOLOGY

The present disclosure relates to augmented reality and, more particularly, to systems and methods for annotating streets in an augmented reality view.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

Augmented reality is increasingly being used to assist people in a wide variety of applications. In the navigation context, for example, augmented reality can be used to overlay real-time camera images/video with annotations of streets and points of interest. However, it has proven to be a challenge to present/overlay augmented reality information on a first-person perspective, three-dimensional (3D) view of the environment in a manner that is useful and easy for a user to understand. In particular, it can be a challenge for users to correlate the street information presented on augmented reality overlays with the real-world view around them. Such correlations can be especially challenging for those who use augmented reality to navigate while walking (e.g., on sidewalks).

For example, it can be difficult for a user to ascertain his/her current location or orientation within a map, or navigate to a desired new location, based only on knowledge of the name of the street closest to his/her current location. Moreover, simply annotating all visible and/or intersecting streets can create visual “clutter” and be difficult for the user to decipher. As another example, it can be difficult for a user to correctly correlate streets of an intersection that he or she can see in the real-world with augmented reality annotations of street names, especially when the intersection is complex (e.g., with three or more streets that intersect at multiple points in a relatively small area near the user).

### SUMMARY

In some implementations described herein, algorithms determine which streets should be annotated, and/or the position and/or format of street annotations, based on factors such as user distance and orientation relative to the streets, and/or the configuration of nearby streets (e.g., whether the nearby streets form a simple intersection, a complex intersection, or no intersection).

In one example implementation, a method of annotating streets to facilitate navigation includes: (1) for a first set of one or more streets that are currently within a real-time, first-person perspective view of a user and intersect a first zone, presenting to the user via a display, by one or more processors, street name annotations according to a first annotation format, wherein the first zone is defined based on distance from the user; and (2) for a second set of one or more streets that are currently within the first-person perspective view but do not intersect the first zone, presenting to the user via the display, by the one or more processors, street name annotations according to a second annotation format different than the first annotation format.

In another example implementation, a method of annotating streets to facilitate navigation of intersections includes: (1) determining, by one or more processors, that a street configuration in an environment of a user is an intersection or a particular type of intersection; and (2) presenting to the user via a display, by the one or more processors and in response to the determining, street name annotations for a first set of one or more streets of the street configuration that are currently within a real-time, first-person perspective view of the user. Presenting the street name annotations includes annotating one or more street segments, of the first set of streets, that satisfy one or more first criteria, and precluding annotation of one or more other street segments, of the first set of streets, that satisfy one or more second criteria, irrespective of whether any street segment of the one or more other street segments is currently within the first-person perspective view.

In another example implementation, a method of annotating streets to facilitate navigation includes: (1) determining, by one or more processors, a first set of one or more streets that are currently within a real-time, first-person perspective view of a user; and (2) for the first set of streets, presenting to the user, via a display and by the one or more processors, one or more street name annotations according to a first annotation format. Presenting the street name annotations for the first set of streets according to the first annotation format includes orienting, in a three-dimensional manner, characters of the street name annotations in an upright position relative to a ground of the environment in the first-person perspective view, and in alignment with directions of the corresponding streets in the first-person perspective view.

In still other implementations, a computing device is configured to implement the method(s) of any one or more of the above implementations.

In still other implementations, one or more non-transitory, computer-readable media store instructions that, when executed by one or more processors, cause the one or more processors to implement the method(s) of any one or more of the above implementations.

### BRIEF DESCRIPTION OF THE DRAWINGS

FIG. 1 is a block diagram of an example system in which techniques for annotating streets in an augmented reality view may be implemented.

FIG. 2 depicts an example user interface with augmented reality street annotations that may be presented to a user, according to one implementation and scenario.

FIG. 3 depicts an arrangement of predefined zones, surrounding a user, that dictate whether a street is to be annotated and/or the annotation format for a street, according to one implementation.

FIGS. 4A-4E depict example scenarios in which the zones of FIG. 3, and example annotation algorithms that make use of such zones, are applied to different street configurations and/or different user positions relative to those street configurations.

FIG. 5 depicts an example intersection cluster formed from more than two intersecting streets, with internal and external street segments.

FIGS. 6A and 6B depict example annotation positions for the intersection cluster of FIG. 5, corresponding to two different user positions.

FIGS. 7-9 are flow diagrams of example methods of annotating streets to facilitate navigation.

### DETAILED DESCRIPTION OF THE DRAWINGS

Generally, aspects of the disclosed invention determine which streets should be annotated, and/or the position and/or format of street annotations, based on factors such as user distance and orientation relative to the streets, and/or the configuration of nearby streets (e.g., whether the nearby streets form a simple intersection, a complex intersection, or no intersection).

In one aspect, an augmented reality system annotates streets that are currently in the user's first-person perspective view and near to the user's position (e.g., streets within a threshold distance/radius of the user's position) according to a first format, but annotates more distant streets that intersect any of those nearby streets according to a second, different format. For example, the first annotation format may be a 3D format, while the second annotation format may be a 2D format. While the nature of a typical display requires that everything be depicted in two dimensions, the 3D format may be understood to include characters displayed such that they are oriented in a 3D manner (i.e., having a 3D appearance to the user, much like a camera-based depiction of the real-world on a smartphone has a 3D appearance to the user despite being shown on a 2D display). In some implementations, the augmented reality system does not provide any annotation for streets that are even further distant from the user's position. For example, the augmented reality system may define three zones based on distance from the user, and either annotate in 3D, annotate in 2D, or not annotate at all based on whether a street intersects the first zone, intersects the second (but not the first) zone, or intersects the third (but not the first or second) zone, respectively.

In another aspect, an augmented reality system determines whether nearby street configurations are an intersection, or a particular type of intersection (e.g., a “complex” intersection, or intersection cluster, that has internal and external street segments or “arms” due to three or more streets intersecting without all sharing a common intersection point), and annotates or does not annotate particular intersection street segments based on various criteria. For example, the augmented reality system may annotate the external street segments currently within the user's first-person perspective view, but not annotate internal street segments irrespective of whether those internal segments are currently within the user's first-person perspective view.

In another aspect, an augmented reality system annotates streets in three dimensions (e.g., in some implementations, only streets that are relatively near the user) by orienting characters of the street name annotations in an upright position relative to the ground of the real-world environment (as depicted in the first-person perspective view), and in alignment with directions of the corresponding streets in the first-person perspective view.

These and other aspects improve readability by users, and/or help users to more quickly and accurately correlate streets that they see in the real world to the street names provided by a navigation or mapping service.

The augmented reality system provides information about an environment surrounding a current location to a user in dependence on the user's position and other real-world data and variables as described herein. The systems, methods, devices, apparatuses, and tangible non-transitory computer-readable media in the disclosed technology each enable the user to manage the technical task of determining information about a user's present location or orientation, or information about an environment surrounding a user's present location, for example to more efficiently navigate to or towards a desired destination.

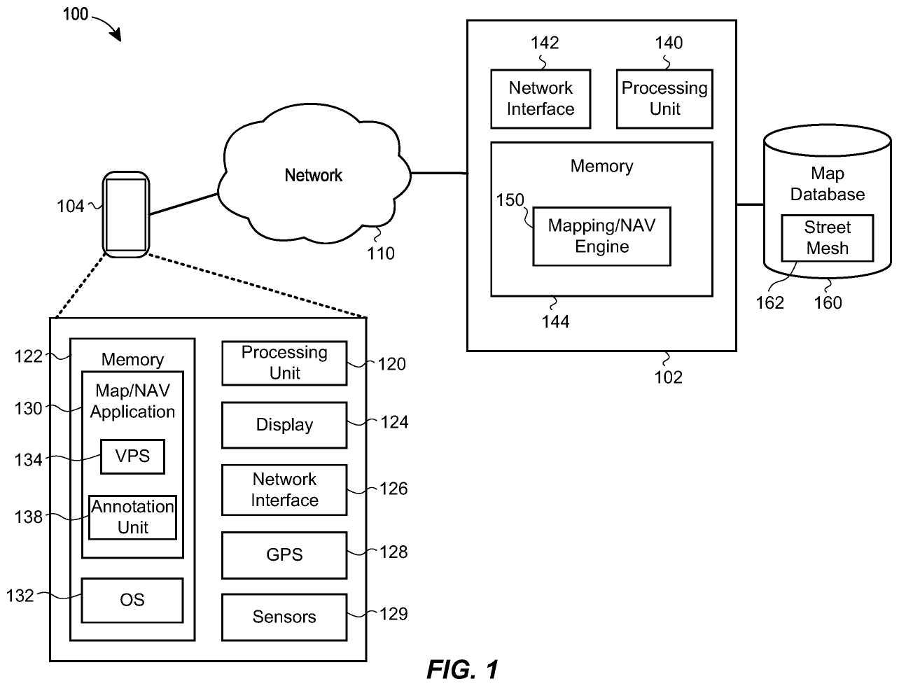

FIG. 1 illustrates an example system 100 in which one or more techniques for facilitating navigation may be implemented. The example system 100 includes a server 102, a mobile communications device 104 of a user, and a network 110. The server 102, which provides mapping and possibly other (e.g., navigation) services, is remote from the mobile communications device 104, and is communicatively coupled to the mobile communications device 104 via the network 110. The network 110 may be a single, wireless communication network (e.g., a cellular network), and in some implementations also includes one or more additional networks. As just one specific example, the network 110 may include a cellular network, the Internet, and a server-side local area network. While FIG. 1 shows only the mobile communications device 104, it is understood that the server 102 may also be in communication with numerous other mobile communications devices similar to the mobile communications device 104. Moreover, while referred to herein as a “server,” the server 102 may, in some implementations, include multiple co-located or remotely distributed computing devices.

While shown in FIG. 1 as having a smartphone form factor, the mobile communications device 104 may be any mobile or portable computing device with wireless communication capability (e.g., a smartphone, a tablet computer, a laptop computer, a wearable device such as smart glasses or a smart watch, a vehicle head unit computer, etc.). In the example implementation of FIG. 1, the mobile communications device 104 includes a processing unit 120, memory 122, a display 124, a network interface 126, a GPS unit 128, and a number of sensors 129. The processing unit 120 may be a single processor (e.g., a central processing unit (CPU)), or may include a set of processors (e.g., multiple CPUs, or one or more CPUs and one or more graphics processing units (GPUs)).

The memory 122 includes one or more computer-readable, non-transitory storage units or devices, which may include persistent (e.g., hard disk) and/or non-persistent memory components. The memory 122 stores instructions that are executable on the processing unit 120 to perform various operations, including the instructions of various software applications and the data generated and/or used by such applications. In the example implementation of FIG. 1, the memory 122 stores at least a map/navigation (NAV) application 130 and an operating system (OS) 132.

Generally, the map/navigation application 130 (and any positioning application) is executed by the processor 120 to access the mapping and navigation services (and positioning services, if available) provided by the server 102. The map/navigation application 130 includes a visual positioning system (VPS) 134 and an annotation unit 138. In general, the VPS 134 associates portions of the user's current real-world view (as captured by one or more cameras of the sensors 129, discussed below) with portions of a 3D model of the environment (also discussed below), while the annotation unit 138 determines when and how to annotate streets and/or street segments that the VPS 134 has already associated with portions of the user's current real-world view. It is understood that, in various implementations, the functionality of each of the VPS 134 and/or the annotation unit 138 may instead be provided by multiple cooperating units or modules, and/or the functionality of both the VPS 134 and the annotation unit 138 may be provided by a single software unit or module, etc.

While the description below refers to a map/navigation “application” 130, it is understood that, in other implementations, other arrangements may be used to access the services provided by the server 102. For example, the mobile communications device 104 may instead access some or all of the mapping/navigation services via a web browser provided by a web browser application stored in the memory 122. In some alternative implementations, the application 130 is only used to access mapping services without navigation services (e.g., without providing step by step instructions for reaching a desired destination).

The display 124 includes hardware, firmware, and/or software configured to enable a user to view visual outputs of the mobile communications device 104, and may use any suitable display technology (e.g., LED, OLED, LCD, etc.). In some implementations, the display 124 is incorporated in a touchscreen having both display and manual input capabilities. Moreover, in some implementations where the mobile communications device 104 is a wearable device, the display 124 is a transparent viewing component (e.g., one or both lenses of smart glasses) with integrated electronic components. For example, the display 124 may include micro-LED or OLED electronics embedded in one or both lenses of smart glasses.

The network interface 126 includes hardware, firmware, and/or software configured to enable the mobile communications device 104 to wirelessly exchange electronic data with the server 102 via the network 110. For example, the network interface 126 may include a cellular communication transceiver, a WiFi transceiver, and/or transceivers for one or more other wireless communication technologies.

The GPS unit 128 includes hardware, firmware, and/or software configured to enable the mobile communications device 104 to self-locate using GPS technology (alone, or in combination with the services of server 102 and/or another server not shown in FIG. 1). Alternatively, or in addition, the mobile communications device 104 may include a unit configured to self-locate, or configured to cooperate with a remote server or other device(s) to self-locate, using other, non-GPS technologies. For example, the mobile communications device 104 may include a unit configured to self-locate using WiFi positioning technology (e.g., by sending signal strengths detected from nearby access points to the server 102 along with identifiers of the access points, or to another server configured to retrieve access point locations from a database and calculate the position of the mobile communications device 104 using trilateration or other techniques).

The sensors 129 include one or more cameras (e.g., charge-coupled device (CCD) cameras, or cameras using any other suitable technology) positioned so as to capture a real-time field of view in front of the user as he or she walks (or otherwise moves) about or changes direction. In implementations where the mobile communications device 104 is a smartphone, for example, the camera(s) and the display 124 may face in opposite directions, to allow the user to view the environment in front of him/her as he/she holds the smartphone generally up and with the display 124 facing his or her face. As another example, in implementations where the mobile communications device 104 is a pair of smart glasses, the camera(s) may be embedded in the frame of the smart glasses, adjacent to one or both lenses of the smart glasses and directed away from the wearer's/user's face. The sensors 129 also include one or more sensors configured to determine a real-time orientation of the mobile communications device 104 within the physical world. For example, the sensors 129 may include an inertial measurement unit (IMU) (e.g., one or more accelerometers, gyroscopes, etc.) configured to generate data indicative of movement of the mobile communications device 104 in three dimensions, including rotational movement around any of the three axes of rotation.

The OS 132 can be any type of suitable mobile or general-purpose operating system. The OS 132 may include application programming interface (API) functions that allow applications to access information from other components of the mobile communications device 104. For example, the map/navigation application 130 may include instructions that invoke an API of the OS 132 to retrieve a current location of the mobile communications device 104 (e.g., as determined by the GPS 128) and an orientation of the mobile communications device 104 (e.g., as determined by one or more of the sensors 129), at particular instances in time.

While FIG. 1 shows a single mobile communications device 104 communicating directly (i.e., via network 110) with the server 102, in some implementations the components of device 104 shown in FIG. 1 are instead divided among two or more user-side devices. For example, a pair of smart glasses may include the processing unit 120, the memory 130, the display 124, and the sensors 128, while a smartphone may include another processing unit and memory, another display, the network interface 126, and the GPS 128. The smart glasses (or smart helmet, etc.) may then communicate as needed with the smartphone (e.g., via Bluetooth) to enable the operations described herein.

The server 102 includes a processing unit 140, a network interface 142, and memory 144. The processing unit 140 may be a single processor, or may include two or more processors. The network interface 142 includes hardware, firmware, and/or software configured to enable the server 102 to exchange electronic data with the mobile communications device 104 and other, similar mobile communications devices via the network 110. For example, the network interface 142 may include a wired or wireless router and a modem.

The memory 144 is a computer-readable, non-transitory storage unit or device, or collection of units/devices, that may include persistent and/or non-persistent memory components. The memory 144 stores instructions of a mapping/navigation engine 150, which may be executed by the processing unit 140. The mapping and navigation components of the mapping/navigation engine 150, or portions thereof (e.g., a routing engine for determining optimal routes based on starting points and destinations) may be provided by separate engines. In some alternative implementations, the memory 144 does not store instructions of a navigation engine (e.g., such that the server 102 is only a mapping server that cannot provide navigation services).

In the example implementation shown, the mapping/navigation engine 150 is generally configured to provide client devices, such as the mobile communications device 104, with mapping and navigation services that are accessible via client device applications, such as the map/navigation application 130. For example, the mapping/navigation engine 150 may receive via the network 110 a navigation request that was entered by the user of the mobile communications device 104 via the map/navigation application 130, and forward a starting point and destination specified by (or otherwise associate with) the navigation request to the mapping/navigation engine 150. The mapping/navigation engine 150 may determine a best (e.g., fastest) route, or set of routes, from the starting point to the destination, and retrieve map information corresponding to a geographic area that includes the determined route(s). The server 102 may retrieve map information from a map database 160, which includes street mesh data 162 and the names associated streets in the street mesh.

Preferably, the map information contained in the map database 160 includes a high-precision, 3D model of the environment, rather than (or in addition to) a 2D model. The 3D model includes not only 2D positional information (e.g., latitude and longitude) but also altitude information for the mapped elements, including streets and their various segments. Thus, the street mesh data 162 may be a connected graph in which edges representing individual streets are series of latitude/longitude/altitude points, and in which nodes represent intersections between two or more streets.

Other data in the map database 160 may include, for example, 3D locations (e.g., latitudes/longitudes/altitudes) and 3D geometries of buildings, and/or locations and names/labels of points-of-interest (POIs), “street view” images aligned with specific 3D locations in the 3D model, and so on. The mapping/navigation engine 150 may then cause the network interface 142 to transmit the relevant 3D map information retrieved from the map database 160, along with any navigation data generated by the mapping/navigation engine 150 (e.g., turn-by-turn text instructions), to the mobile communications device 104 via the network 110. The map database 160 may consist of just one database or comprise multiple databases, and may be stored in one or more memories (e.g., the memory 144 and/or another memory) at one or more locations.

In at least one mode of operation, the map/navigation application 130 can provide a dynamic, first-person perspective, augmented reality view of the user's real-world environment, substantially in real-time as the user moves the mobile communications device 104 through (and/or rotates or otherwise reorients the mobile communications device 104 within) that environment. To provide the “real-world” portion of the first-person perspective view, the map/navigation application 130 presents (via the display 124) a real-time view of the user's environment comprising sequential (video) images/frames captured by the camera(s) 129. Alternatively (e.g., if the mobile communications device 104 is a pair of smart glasses), the real-time view can be the portion of the real world that the user directly observes through one or more lenses, with the camera(s) of the sensors 129 and the lens(es) of the device 104 being configured such that the camera field of view at least approximates the user's field of view at any given time.

In order to overlay or otherwise augment that real-time view with the appropriate map information, the VPS 134 continuously or periodically performs geo-localization. In particular, the VPS 134 repeatedly (e.g., periodically) determines the current location of the mobile communications device 104, as well as the current orientation of the mobile communications device 104, within the physical world, and determines which portions of the 3D model of the environment correspond to that location and orientation (field of view). The VPS 134 may determine the device position/location using the GPS 128 (e.g., by using an API of the OS 132 to obtain from the GPS 128 the latitude, longitude, and altitude of the mobile communications device 104), or another self-localization component of the mobile communications device 104, and may determine the device orientation using an IMU of the sensors 129 (e.g., by using an API of the OS 132 to obtain from the IMU absolute or differential orientation information). The VPS 134 uses this position and orientation information to determine which portions of the 3D model of the environment are currently within the user's field of view, either by accessing the 3D model via the server 102, or by accessing a local portion of the 3D model that was previously downloaded (e.g., pre-fetched), depending on the implementation and/or scenario. In some implementations, the VPS 134 also uses camera images (obtained by one or more cameras of the sensors 129) to correlate the real-world view to elements of the 3D model, e.g., by matching 2D planes detected in the camera images to 2D planes in the 3D model.

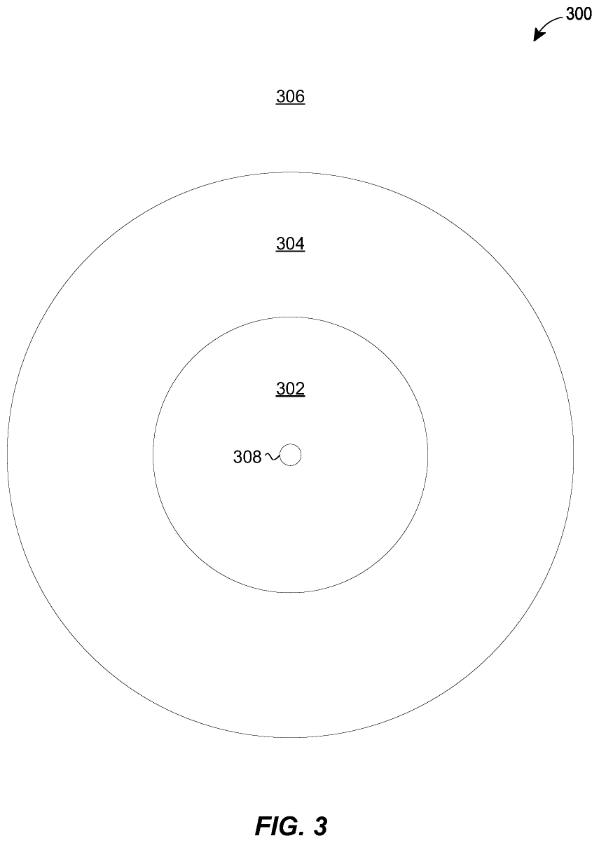

The VPS 134 uses the information generated by the IMU to determine the direction (in azimuth and elevation) in which the mobile communications device 104 is currently facing, and then determines which portion of the 3D model corresponds to objects (e.g., streets) that can be seen in that direction. In some implementations, for purposes of view augmentation, the VPS 134 only determines which portion of the 3D model of the environment corresponds to objects that are within a threshold distance of the device 104 (e.g., up to the outer boundary shown in FIG. 3, discussed below).

Once the VPS 134 has geo-localized the mobile communications device 104 and determined the corresponding portions/elements of the 3D model, the map/navigation application 130 can use the elements of the 3D model to augment the real-world view presented on (or otherwise visible through) the display 124. This augmentation includes annotating one or more objects within the view, including at least one street (e.g., if any streets are currently within the view and within any threshold distance) and possibly other objects (e.g., particular buildings or other POIs).

Annotations of objects in the view of the real world provided on (or otherwise visible through) the display 124 can assist the user in navigating through his or her environment. For safety and other reasons, such annotations may be particularly helpful to a person who is walking (e.g., on street sidewalks) rather than driving, although the annotations may also be useful to those in vehicles (e.g., in a passenger seat of a car). The annotations include street annotations, as described in further detail below, and in some implementations can also include one or more other types of annotations (e.g., POI annotations). Moreover, in some implementations, the map/navigation application 130 may augment the real-world view with other information, such as the current time and/or date, the city in which the user is currently located, and so on.

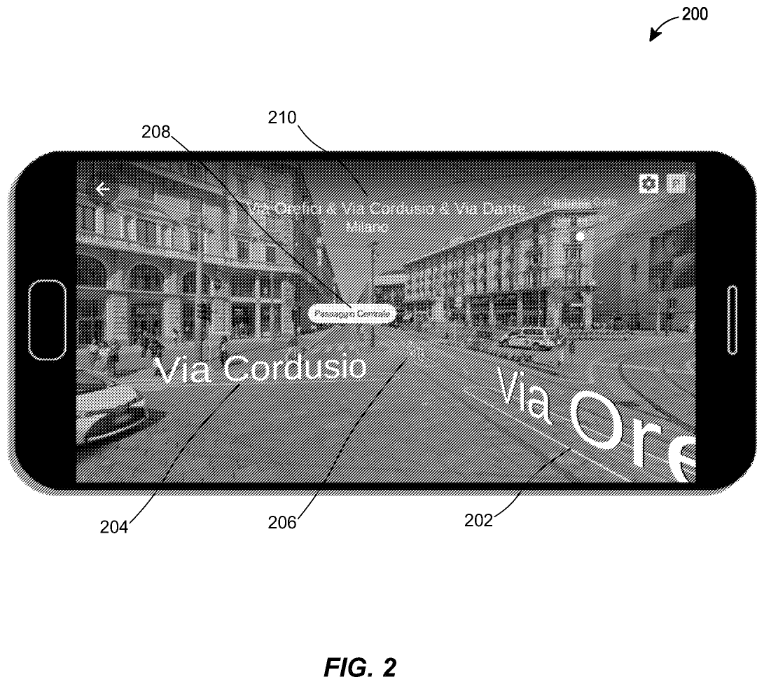

In the example system 100, annotation is performed in full, or in part (e.g., only the street annotations), by the annotation unit 138, after the VPS 134 has associated the various portions of the user's real-world view (as detected by one or more cameras of the sensors 129) with corresponding portions (including streets) of the 3D model of the environment. The annotation unit 138 annotates streets, currently within the real-world view presented on (or otherwise visible through) the display 124, according to one or more algorithms that help the user to properly identify the roads that he or she can see nearby. For example, the algorithm(s) may provide dynamic annotation that lowers the risk of the user misattributing street names to actual streets or street segments, and/or reduces the amount of time required for the user to properly attribute street names to streets or street segments (e.g., by reducing visual “clutter”). An example user interface 200 with augmented reality street annotations, which the map/navigation application 130 may present to a user via the display 124, is shown in FIG. 2, according to one implementation and scenario. The example user interface 200 will be referred to below to illustrate various techniques/algorithms that may be implemented by the annotation unit 138 or the map/navigation application 130 more generally.

Generally, the algorithms implemented by the annotation unit 138 may determine which streets should be annotated, the real-world position of street annotations, how to portray the names of near streets relative to distant streets, how to handle special street configurations (e.g., intersections or complex intersections), and/or how a user can interact with street annotations. It is understood that the annotation unit 138, or the map/navigation application 130 more generally, may execute any one of the following algorithms, or, in some implementations, may execute two or more of the following algorithms. While the following description refers to various conditions for annotating a street or street segment, or for annotating a street or street segment according to a particular format, it is understood that the corresponding algorithms may also apply the condition that the street or street segment must be within the real-world view shown on or otherwise visible through the display 124 in order for the annotation unit 138 to annotate the street or street segment. However, other implementations are also possible, such as the annotation unit 138 annotating streets or street segments that are within some threshold distance (or threshold azimuth angle, etc.) of the current real-world view, for example. In some implementations, the annotation unit 138 precludes annotation of a street if the VPS 134 (or the map/navigation application 130 more generally) determines that the street is occluded from the user's view, or occluded to at least some threshold degree, by one or more buildings or other structures represented in the 3D model.

In some implementations, the annotation unit 138 determines the format in which to annotate a given street, and/or whether to annotate a given street at all, based at least in part on how distant that street is from the user. It is understood that references to the location of the “user” (or distances from the “user,” etc.) herein refer to the location of (or distance from, etc.) the mobile communications device 104 of the user, and that such locations are necessarily determined with less than 100% precision and/or accuracy.

In particular, the annotation unit 138 may define a number of “zones” based on distance from the user, and determine how and whether to annotate each street based on the nearest zone that the street intersects. In some implementations, for example, the annotation unit 138 annotates streets that are currently within the first-person perspective view and intersect a first (nearest) zone according to a first annotation format, but, for one or more streets that are currently within the first-person perspective view but do not intersect the first zone, annotates the street(s) according to a second, different annotation format.

An example arrangement 300 of three predefined zones 302, 304, 306 is shown in FIG. 3. In the example of FIG. 3, the zones 302, 304, 306 are circular zones defined relative to the location 308 of the user/device 104, specifically based on fixed distances/radii from the location 307 and with each successive zone away from the location 308 being immediately adjacent to the preceding/closer zone. For example, zone 302 may be a circular area with a 30 meter radius around the location 308, zone 304 may be an annular area defined by boundaries at 30 and 60 meters radius around the location 308, and zone 306 may be an area defined as being outside a 60 meter radius around the location 308. In another example implementation, the zones 302, 304, 306 may be similarly defined, but with the boundary between zones 304 and 306 being at a 120 meter radius around the location 308. In still other implementations, the arrangement 300 consists of fewer zones (i.e., only two zones), more zones (e.g., four zones, five zones, etc.), and/or zones having boundaries that are not defined by a radius from the location 308 (e.g., with one or more zones being polygonal). In some implementations, the map/navigation application 130 can dynamically adjust the size of each zone 302, 304, 306, e.g., based on whether the user is in a country, city, or other area where street corners tend to be closer together or further apart. In other implementations, the user can manually select a mode that controls the size of each zone 302, 304, 306.

The annotation unit 138 annotates (or precludes annotation of) streets in a manner dependent upon which of the zones 302, 304, 306 the streets intersect. For example, the annotation unit 138 may annotate streets that intersect zone 302 according to a first annotation format, annotate streets that intersect zone 304 (but not zone 302) according to a second annotation format, and preclude any annotation of streets that only intersect zone 306. In a more specific example, the first annotation format in which the characters (e.g., letters and/or numbers) of the street annotation are overlaid on the camera frames in a three-dimensional manner, and the second annotation format may be a format in which the characters of the street annotation are overlaid on the camera frames in a two-dimensional manner.

The annotation unit 138 may create a three-dimensional appearance for the first annotation format by aligning the characters of a street annotation with the direction of the corresponding street in the first-person perspective view on the display 124. That is, a horizontal axis of the characters may be oriented parallel to a direction of the street and a vertical axis of the characters may be oriented normal (orthogonal/perpendicular) to the surface of the street. In this way, the axes of the characters may not be parallel to those of the display unless the axis of the street direction is parallel to an axis of the display. The characters may be described as being displayed in a perspective or axonometric view relative to the display. The annotation unit 138 may emphasize the three-dimensional appearance by gradually adjusting the size of the characters based on distance from the user (or more precisely, based on distance of the corresponding real-world positions from user/device 104) to create the perspective view. The annotation unit 138 may cause characters of street annotations to follow the slopes (altitude changes) of the corresponding streets, as indicated by the 3D model and/or as detected in the camera images. In various implementations, the annotation unit 138 may cause the characters of a single annotation to follow changes of slope in the corresponding street, to loosely follow changes of slope in the corresponding street (e.g., while avoiding abrupt changes in slope), or to follow a straight line that represents an average slope (or mid-point slope, etc.) of the corresponding street.

The annotation unit 138 may create the two-dimensional appearance by maintaining a fixed or uniform character size on the display 124, and/or by displaying the characters in a “primary” or “elevation” view (i.e., in which the axes of the characters are maintained parallel to those of the display independently of the orientation of the street relative to the display), and/or by not aligning the characters of the street annotation with the direction of the corresponding street. The first and second annotation formats may also differ in one or more other respects (e.g., with annotations of the second annotation format, but not the first annotation format, having a banner-like appearance with a background and border). In some implementations, the annotation unit 138 refreshes the annotation formats periodically (e.g., every 5 seconds), but maintains a fixed annotation format for any annotation while that annotation is within the first-person perspective view.

In some alternative implementations, the annotation unit 138 annotates at least some streets with a three-dimensional annotation format, but does not apply a different annotation format to any other streets based on zone or distance. For example, the annotation unit 138 may annotate the street nearest the user (or all streets within a threshold distance of the user, etc.) with a three-dimensional format, and simply preclude annotation of all other streets irrespective of whether those other streets are currently within the first-person perspective view.

The example user interface 200 of FIG. 2 shows an example first-person perspective view with possible first and second annotation formats. In particular, the user interface 200 shows an area in which three streets intersect a first zone (e.g., zone 302) and therefore have annotations 202, 204, 206 according to the first annotation format (in this example, a three-dimensional annotation format), while a more distant street intersects a second zone (e.g., zone 304) but not the first zone, and therefore has an annotation 208 according to the second annotation format (in this example, a two-dimensional, banner-like annotation format). As seen in FIG. 3, the annotation unit 138 may orient each annotation within the first-person perspective view such that the street name reads left to right (or possibly, in specific scenarios, top to bottom) on the display 124. As is also seen in FIG. 2, the map/navigation application 130 may further augment the first-person perspective view with other information, such as the information 210 indicating the street names of the intersection and the city (or the neighborhood, etc.).

In some implementations, the annotation unit 138 only annotates a given street if the street is currently within the first-person perspective view, intersects a zone for which annotations are designated (e.g., zone 302 or 304), and either: (1) is nearer to the user than any other street in the first-person perspective view, or (2) intersects the street that is nearer to the user than any other street in the first-person perspective view. In other implementations, the annotation unit 138 does not require that a given street intersect the street nearest the user in order to provide annotation of the former (e.g., the annotation unit 138 may annotate parallel streets so long as those parallel streets are currently in the first-person perspective view and intersect a zone for which annotation is designated).

In some implementations, the annotation unit 138 annotates the street that is nearest to the user, and within the first-person perspective view, at a position corresponding to the nearest to the user along the street. For example, the annotation unit 138 may determine the point nearest to the user, and start a three-dimensional annotation at that point, or center a three-dimensional annotation on that point, etc. The annotation may have a minimum character size, which may require that the user scan the surrounding area with the mobile communications device 104 in order to see the entire street name (e.g., as is the case with the annotation 202 in FIG. 2). While this approach may require some movement of the user and/or the device 104 to see an entire street name, in some scenarios, it can nevertheless reduce the likelihood (in certain situations) that the user becomes confused and unable to identify the street or street segment for which the annotation is intended.

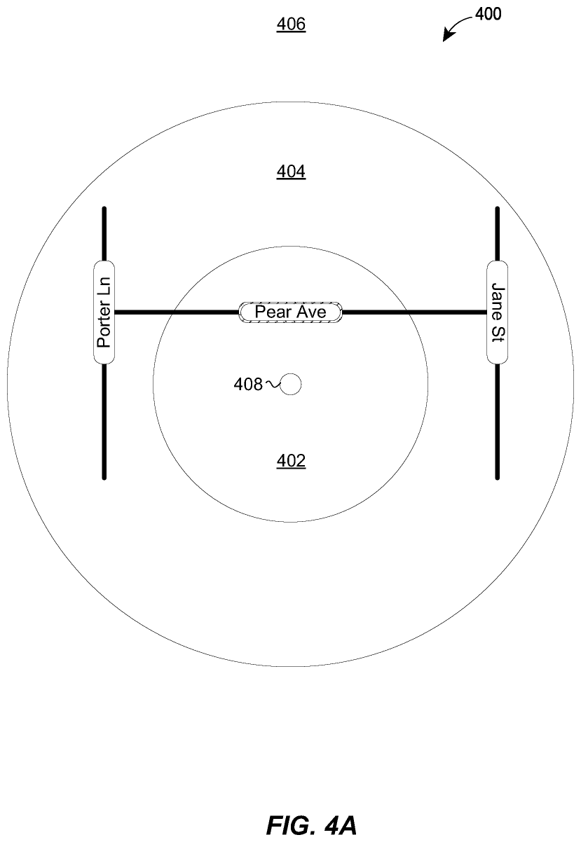

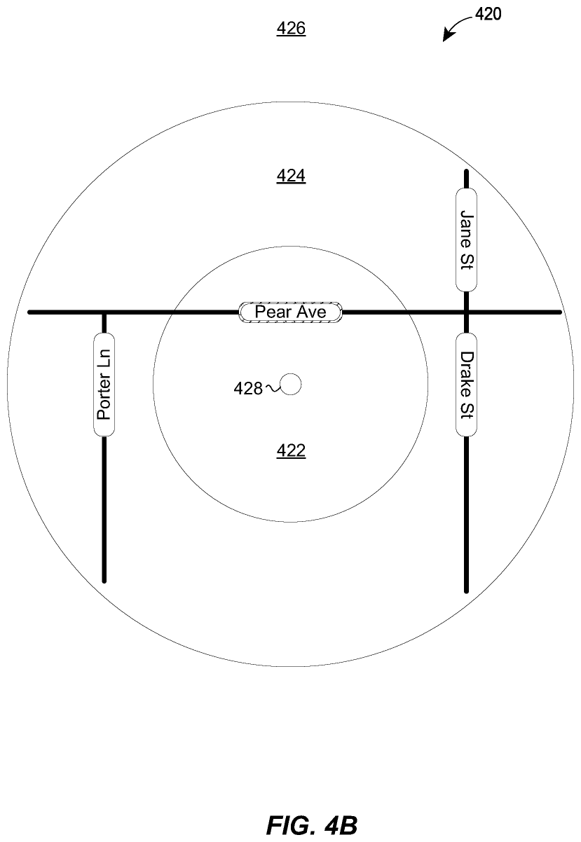

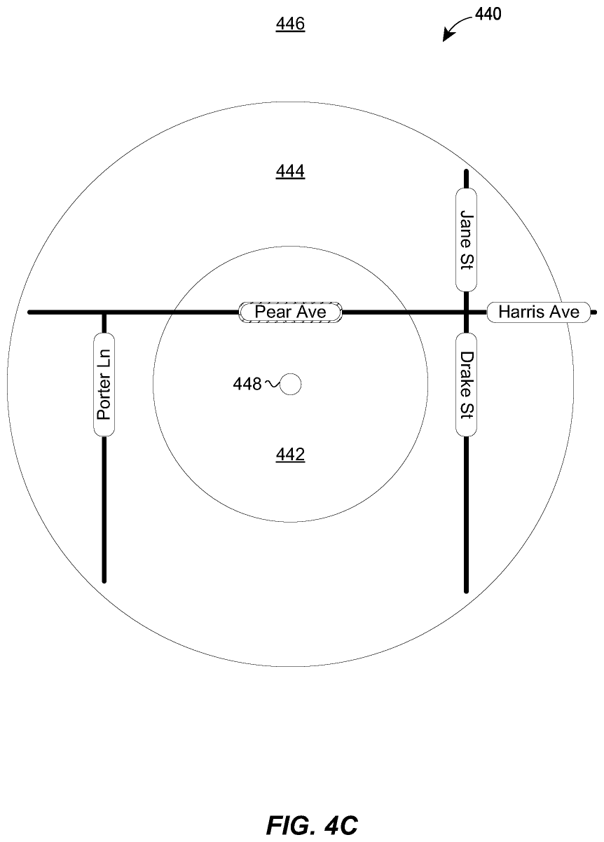

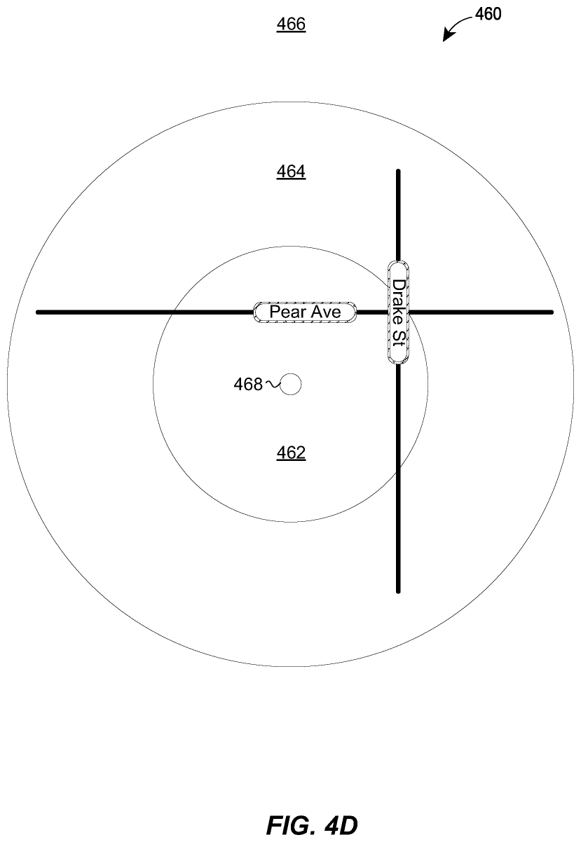

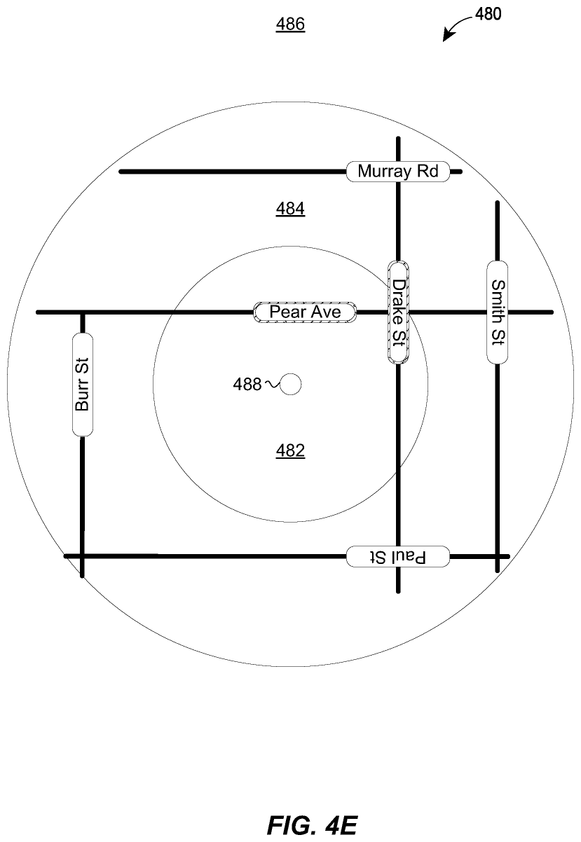

FIGS. 4A-4E depict example implementations and scenarios in which the zones of FIG. 3, and example annotation algorithms that make use of such zones, are applied to different street configurations and/or different user positions relative to those street configurations. FIGS. 4A-4E are overhead views and thus do not represent the first-person perspective view provided by map/navigation application 130 on (or otherwise visible through) the display 124. However, the positions of the various street labels shown in FIGS. 4A-4E represent the positions of the street annotations within the first-person perspective view, when and if the user/device 104 is facing in a direction that would bring the labels into view. In FIG. 4A, for example, the user would see the annotation “Pear Ave” only when facing the camera(s) of the device 104 in a direction that provides a view of the real-world position corresponding to at least a portion of that annotation, and would see the annotation “Jane St” only when facing the camera(s) of the device 104 in a direction that provides a view of the real-world position corresponding to at least a portion of that annotation, etc. Also in FIGS. 4A-4E, labels with a thicker, dashed-line border correspond to annotations in accordance with a first annotation format (e.g., the three-dimensional annotation format discussed above), while labels a simple, single-line border correspond to annotations in accordance with a different, second annotation format (e.g., the two-dimensional annotation format discussed above).

Referring first to a scenario 400 of FIG. 4A, zones 402, 404, 406 may be similar to zones 302, 304, 306, respectively, of FIG. 3, and location 408 may be the user/device 104 location similar to location 308 of FIG. 3. In the scenario 400, the user is nearest to Pear Ave. Because Pear Ave. intersects zone 402, the annotation unit 138 annotates the street with the characters “Pear Ave” using the first annotation format. Moreover, in some implementations, the annotation unit 138 positions (e.g., centers) the annotation on a point or segment of the street that is nearest to the user location 408.

Also in the scenario 400, Pear Ave. intersects with two streets (Porter Ln. and Jane St.) in opposing directions. Because these streets intersect zone 404 but not zone 402, the annotation unit 138 annotates Porter Ln. and Jane St. according to the second annotation format. Throughout this disclosure, it is understood that any references to conditions requiring that a street does not intersect with a particular zone can encompass, for example: (1) implementations in which the street cannot intersect any portion of the zone; or (2) implementations in which the street cannot intersect any portion of the zone that is currently within the first-person perspective view, but may intersect a portion of the zone that is not currently within the first-person view. Moreover, it is understood that throughout this disclosure, any references to conditions requiring that a further street intersect a closer street can encompass, for example: (1) implementations in which the street intersection can be at any real-world position; or (2) implementations in which the street intersection must currently be within the first-person perspective view.

In the example shown, the annotation unit 138 centers the “Porter Ln” and “Jane St” annotations on their respective intersections with Pear Ave. An example of such positioning is shown in FIG. 2, for the annotation 208 “Passaggio Centrale.” In some implementations (as discussed further below), the annotation unit 138 only centers such annotations on the street intersection if the crossing street (i.e., the street crossing the street that comes closer to the user) does not have a different name on both sides of the intersection. Additionally or alternatively, the annotation unit 138 may only center such annotations on the street intersection if the street intersection is a T-intersection at which the street closer to the user comes to an end.

If Porter Ln. and Jane St. instead intersected zone 406 but not zone 404 (e.g., if the user were near the middle of a sufficiently large block), the annotation unit 138 would not annotate Porter Ln. or Jane St. (irrespective of whether the user could actually see those streets/intersections in the first-person perspective view), and thus the user would only be able to see the annotation for Pear Ave (if looking in a direction that allows him or her to see the annotation).

Referring next to a scenario 420 of FIG. 4B, zones 422, 424, 426 may be similar to zones 302, 304, 306, respectively, of FIG. 3, and location 428 may be the user/device 104 location similar to location 308 of FIG. 3. In the scenario 420, the user is again nearest to Pear Ave. Because Pear Ave. intersects zone 422, the annotation unit 138 annotates the street with the characters “Pear Ave” using the first annotation format. Moreover, in some implementations, the annotation unit 138 positions (e.g., centers) the annotation on a point or segment of the street that is nearest to the user location 428.

Also in the scenario 420, Pear Ave. intersects with one street (Porter Ln.) in one direction, in a T-intersection, and in the other direction intersects with two streets (i.e., a roadway that has different names, Jane St. and Drake St., on the two sides of Pear Ave.). Because Porter Ln. intersects zone 424 but not zone 422, the annotation unit 138 annotates Porter Ln. according to the second annotation format. Moreover, because the intersection is a T-intersection with the street nearer to the user (i.e., Pear Ave.) forming the top of the “T” shape, the annotation unit 138 positions the “Porter Ln” annotation entirely on Porter Ln. (rather than on the intersection, as shown in FIG. 4A).

In the other direction, because Jane St. and Drake St. intersect zone 424 but not zone 422, the annotation unit 138 annotates Jane St. and Drake St. according to the second annotation format. Moreover, because the intersection involves a change of street name when crossing the street nearer to the user (i.e., when crossing Pear Ave.), and to avoid user confusion as to which annotation corresponds to which street, the annotation unit 138 positions the “Jane St” and “Drake St” annotations entirely on the respective sides of Pear Ave. (rather than on the intersection, as shown in FIG. 4A).

For each of the “Porter Ln,” “Jane St,” and “Drake St” annotations, the annotation unit 138 may “snap” the annotation to the respective intersection with Pear Ave. For example, the annotation unit 138 may position each annotation a predetermined, fixed distance (in real-world terms or in terms of pixel distance in the first-person perspective view) from the respective intersection. The distance may be determined relative to the end (e.g., last character) of any given annotation, for example. The distance may be set so as to provide optimal or near-optimal clarity for the user across a variety of real-world scenarios.

Referring next to a scenario 440 of FIG. 4C, zones 442, 444, 446 may be similar to zones 302, 304, 306, respectively, of FIG. 3, and location 448 may be the user/device 104 location similar to location 308 of FIG. 3. In the scenario 440, the user is again nearest to Pear Ave. Because Pear Ave. intersects zone 422, the annotation unit 138 annotates the street with the characters “Pear Ave” using the first annotation format. Moreover, in some implementations, the annotation unit 138 positions (e.g., centers) the annotation on a point or segment of the street that is nearest to the user location 448.

Also in the scenario 440, Pear Ave. intersects with one street (Porter Ln.) in one direction, in a T-intersection, and in the other direction intersects with two streets (i.e., a roadway that has different names, Jane St. and Drake St., on the two sides of Pear Ave.). Further, in the scenario 440, Pear Ave. becomes Harris Ave. after the intersection with Jane St. and Drake St. The annotation unit 138 annotates Porter Ln., Jane St., and Drake St. in the same manner, and for the same reasons, as described above with reference to FIG. 4B. Moreover, because Pear Ave. becomes Harris Ave. after the intersection, the annotation unit 138 positions a “Harris Ave” annotation shortly beyond (i.e., further from the user relative to) the intersection. As with the “Jane St” and “Drake St” annotations, to avoid user confusion as to which annotation corresponds to which street, the annotation unit 138 does not position the “Harris Ave” annotation on the intersection itself. For each of the “Porter Ln,” “Jane St,” “Drake St,” and “Harris Ave” annotations, the annotation unit 138 may “snap” the annotation to the respective intersection with Pear Ave, as discussed above with reference to FIG. 4B.

Referring next to a scenario 460 of FIG. 4D, zones 462, 464, 466 may be similar to zones 302, 304, 306, respectively, of FIG. 3, and location 468 may be the user/device 104 location similar to location 308 of FIG. 3. In the scenario 460, the user is again nearest to Pear Ave. Because Pear Ave. intersects zone 462, the annotation unit 138 annotates the street with the characters “Pear Ave” using the first annotation format. Also in the scenario 460, Pear Ave. intersects with one street (Drake St.) in one direction, with the Drake St. also intersecting zone 462. In the other direction, Pear Ave. does not intersect with any streets, at least until somewhere in zone 466 (not shown in FIG. 4D). Because Drake St. intersects zone 462 (and, in some implementations, because Drake St. intersects Pear Ave.), the annotation unit 138 annotates Drake St. according to the first annotation format. Moreover, because Drake St. maintains its same name across the intersection, the annotation unit 138 positions (e.g., centers) the “Drake St” annotation on the intersection with Pear Ave. An alternative scenario in which a street changes its name across an intersection that is within zone 462 is shown in FIG. 2, specifically for the annotations 202 and 206 (“Via Orefici” and “Via Dante”).

In the scenario 460, because the intersection occurs in zone 462 (and thus, both intersecting streets also intersect zone 462), the annotation unit 138 does not position the “Pear Ave” annotation in the same manner as FIGS. 4A-4C. Instead, the annotation unit 138 “snaps” the annotation to the intersection, e.g., as discussed above with reference to FIG. 4B. Because Drake St. does not change its name across the intersection, the annotation unit 138 positions (e.g., centers) the annotation on the intersection.

Referring next to a scenario 480 of FIG. 4E, zones 482, 484, 486 may be similar to zones 302, 304, 306, respectively, of FIG. 3, and location 488 may be the user/device 104 location similar to location 308 of FIG. 3. In the scenario 480, the user is again nearest to Pear Ave. Because Pear Ave. intersects zone 482, the annotation unit 138 annotates the street with the characters “Pear Ave” using the first annotation format. Also in the scenario 480, Pear Ave. intersects with Drake St. at a point within zone 482. Thus, the annotation unit 138 annotates Pear Ave. and Drake St. in the same manner discussed above with reference to FIG. 4D.

In the other direction, Pear Ave. intersects with Burr St. (which intersects zone 484 but not zone 482) in a T-intersection, with Pear Ave. forming the top of the “T” shape. Thus, the annotation unit 138 annotates Burr St. in a manner similar to Porter Ln. in FIG. 4C. Beyond the intersection with Drake St., Pear Ave. intersects Smith St. Because Smith St. intersects zone 484 but not zone 482, the annotation unit 138 annotates Smith St. according to the second annotation format. Moreover, because Smith St. does not change its name across the intersection, the annotation unit 138 positions (e.g., centers) the “Smith St” annotation on the intersection with Pear Ave.

FIG. 4E also depicts two intersections that do not involve the street nearest to location 488 (i.e., Pear Ave.). In some implementations, the annotation unit 138 precludes any annotation of streets that do not intersect with the street nearest to the user. In the example implementation of FIG. 4E, however, the annotation unit 138 does annotate such streets so long as those streets intersect zone 482 and/or zone 484 (and, in some implementations, so long as those streets intersect a street that in turn intersects the street nearest to the user). Thus, the annotation unit 138 annotates Murray Rd. and Paul St. according to the second annotation format, because each intersects zone 484 but not zone 482. Moreover, in the implementation shown, and because neither Murray Rd. nor Paul St. changes its name across the intersection, the annotation unit 138 positions (e.g., centers) the “Murray Rd” and “Paul St” annotations on their respective intersections.

For the examples of FIGS. 4A-4C, the annotation unit 138 (or another component of the map/navigation application 130) may need to determine whether a particular street configuration is an “intersection.” For example, the annotation unit 138 may only “snap” street annotations to intersections in the manner noted above if the annotation unit 138 (or map/navigation application 130 more generally) first determines that those streets form intersections with other nearby streets.

Additionally or alternatively, in some implementations, the annotation unit 138 (or map/navigation application 130 more generally) may determine whether a nearby street configuration (e.g., within or partially within zone 302) is a particular type of intersection, and annotate street segments of that intersection in accordance with an algorithm that is specific to that type of intersection. For example, the annotation unit 138 may apply special annotation rules if the map/navigation application 130 determines that an intersection in zone 302 is a “complex” intersection (also referred to herein as an “intersection cluster”) with both internal and external street segments or “arms” formed by three or more streets (or possibly four or more streets) that all intersect in a relatively small area (e.g., all within zone 302), but do not all intersect at the same point. Stated differently, a complex intersection or intersection cluster is a set of multiple intersections in near proximity to each other, which the annotation unit 138 identifies and treats as a single intersection (but according to specialized rules that are not applicable, or otherwise not used, for simple intersections).

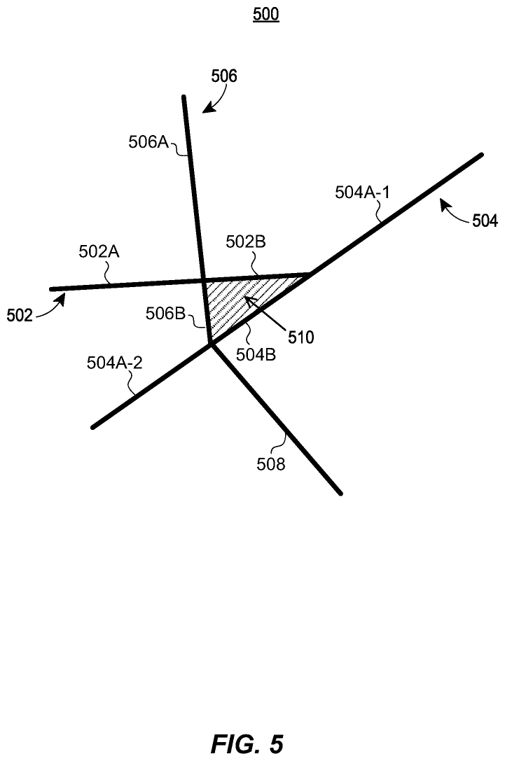

FIG. 5 provides an example of one such intersection 500, with streets 502, 504, 506, and 508 intersecting in such a way as to form an enclosed area 510. In this example, the street 502 includes an external segment 502A and an internal segment 502B, the street 504 includes external segments 504A-1, 504A-2 and an internal segment 504B, the street 506 includes an external segment 506A and an internal segment 506B, and the street 508 is entirely external. The internal segments 502B, 504B, and 506B form the boundaries of the enclosed area 510. In some implementations, the map/navigation application 130 determines that the intersection 500 is an intersection cluster only if all of the constituent intersections that form the complex intersection are within a threshold distance (e.g., 15 meters) of each other. In other implementations, the map/navigation application 130 determines that the intersection 500 is an intersection cluster only if the enclosed area 510 (and thus, all of the constituent intersections that form the complex intersection) is entirely within zone 302, only if the enclosed area 510 is partially within a threshold distance from the user/device 104, only if all internal segments 502B, 504B, 506B intersect a zone defined by that threshold distance, and/or based on some other suitable condition or conditions. The threshold distance may be the same distance that defines zone 502 (e.g., 30 meters), or may be a different distance (e.g., a smaller distance such as 15 meters).

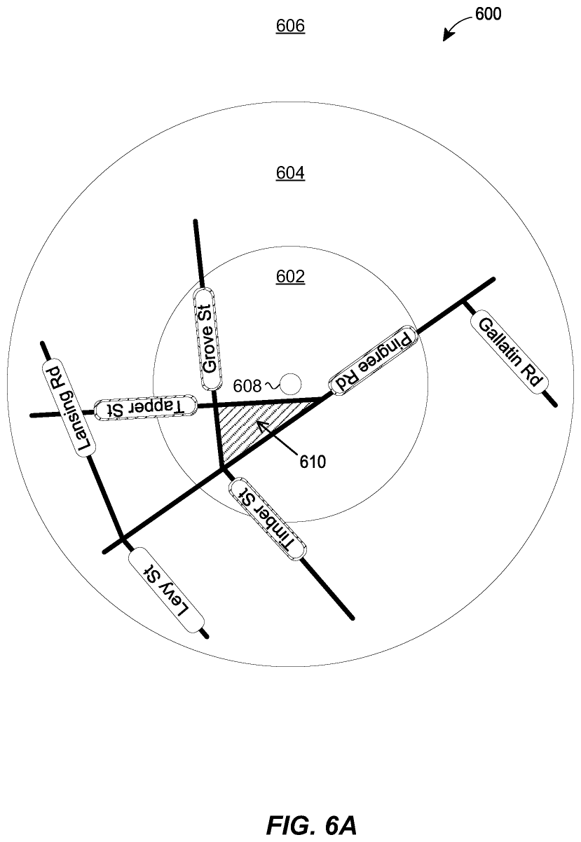

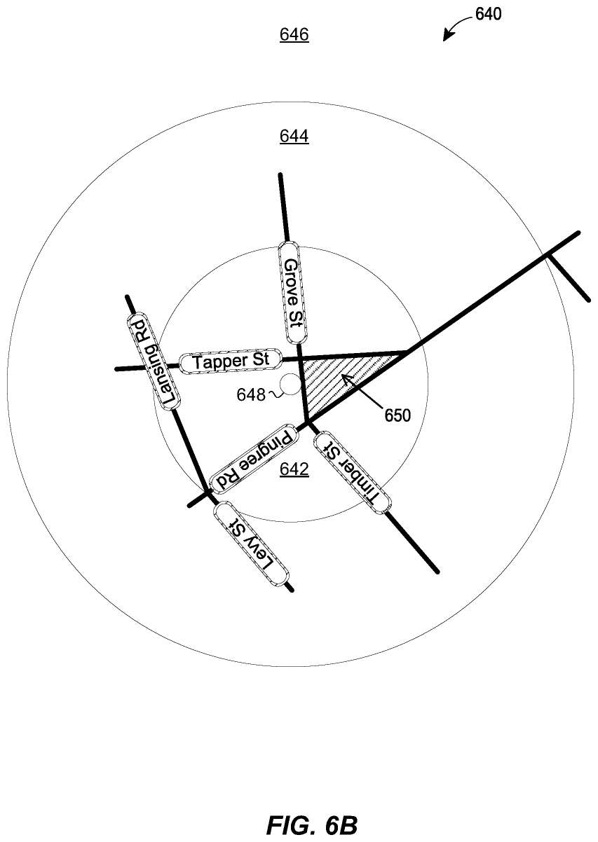

FIGS. 6A and 6B depict different ways in which the annotation unit 138 may annotate the first-person perspective view, depending on the position of the user/device 104 relative to the intersection 500. As with FIGS. 4A-4E, FIGS. 6A and 6B are overhead views that do not represent the first-person perspective view provided by map/navigation application 130 on (or otherwise visible through) the display 124, and the positions of the various street labels shown in FIGS. 6A and 6B represent the positions of the street annotations within the first-person perspective view, when and if the user/device 104 is facing in a direction that would bring the labels into view. Also as in FIGS. 4A-4E, labels with a thicker, dashed-line border correspond to annotations in accordance with a first annotation format (e.g., the three-dimensional annotation format discussed above), while labels a simple, single-line border correspond to annotations in accordance with a different, second annotation format (e.g., the two-dimensional annotation format discussed above). As seen in the following examples, the annotation unit 138 may annotate external segments/arms of an intersection cluster, but preclude annotation of internal segments/arms of the intersection cluster, in order to cause less confusion to users trying to correlate street segments to street names.

Referring first to a scenario 600 of FIG. 6A, zones 602, 604, 606 may be similar to zones 302, 304, 306, respectively, of FIG. 3, and location 608 may be the user/device 104 location similar to location 308 of FIG. 3. In the scenario 600, the user is nearest to the internal segment of Tapper St. (corresponding to internal segment 502B in FIG. 5), which forms part of a boundary of an enclosed area 610. Because the map/navigation application 130 identified the street configuration as an intersection cluster, however, the annotation unit 138 does not annotate Tapper St. at a location that is nearest to the user location 608. Instead, the annotation unit 138 responds to the identification of the intersection cluster by annotating only external segments of Tapper St., Grove St., Pingree Rd., and Timber St. (here, external segments 502A, 504A-1, 506A and street 508 in FIG. 5). The annotation unit 138 may “snap” each of those annotations to a position near a vertex of the intersection cluster, e.g., as discussed above with reference to FIG. 4A. In some implementations, the annotation unit 138 decides which vertex to “snap” an annotation to by selecting the vertex that both includes the street being annotated and is closest to the user/device 104 (location 608). The result is that the annotation unit 138 annotates each street involved in the intersection cluster on the external segment/arm of that street that is closest to the user/device 104. The annotation unit 138 also annotates Tapper St., Grove St., Pingree Rd., and Timber St. according to the first annotation format, because all of those streets intersect zone 602.

Also in the scenario 600, two streets involved in the intersection cluster (Tapper St. in one location, and Pingree Rd. in two other locations) intersect with other streets at intersections that are not part of the intersection cluster. In the scenario 600, those other streets (Lansing Rd., Levy St., and Gallatin Rd.) each intersect zone 604 but not zone 610, and therefore are annotated by the annotation unit 138 according to the second annotation format. Because Lansing Rd. crosses Tapper St. without a name change, the annotation unit 138 positions (e.g., centers) the “Lansing Rd” annotation on the intersection. Because the roadway corresponding to Levy St. changes names across Pingree Rd., the annotation unit 138 “snaps” the “Levy St” annotation to the side of the intersection corresponding to that street. Finally, because Gallatin Rd. forms a T-intersection with Pingree Rd. (with Pingree Rd. forming the top of the “T” shape), the annotation unit 138 “snaps” the “Gallatin Rd” annotation to the side of the intersection corresponding to that street.

Scenario 640 of FIG. 6B represents a scenario in which the user moved to a different side of the intersection cluster. In FIG. 6B, zones 642, 644, 646 may be similar to zones 302, 304, 306, respectively, of FIG. 3, and location 648 may be the user/device 104 location similar to location 308 of FIG. 3. In the scenario 640, the user is nearest to the internal segment of Grove St. (corresponding to internal segment 506B in FIG. 5), which forms part of a boundary of an enclosed area 650. Because the map/navigation application 130 identified the street configuration as an intersection cluster, however, the annotation unit 138 does not annotate Grove St. at a location that is nearest to the user location 648. Instead, the annotation unit 138 responds to the identification of the intersection cluster by annotating only the external portions of Tapper St., Grove St., Pingree Rd., and Timber St. (corresponding to external segments 502A, 504A-2, 506A and street 508 in FIG. 5). This results in annotations similar to the scenario 600 of FIG. 6A but, because the user is now closer to a different segment of Pingree Rd. (i.e., segment 504A-2 rather than 504A-1), the annotation unit 138 “snaps” the “Pingree Rd” annotation to the vertex associated with that other segment (i.e., segment 504A-2).

In some implementations, the annotation unit 138 also, or instead, applies other algorithms not discussed above. For example, the annotation unit 138 may position all annotations in a manner that ensures no annotation in a first annotation format (e.g., three-dimensional annotations as discussed above) occludes another annotation in the same format (e.g., by shifting, along their respective streets, one or both of two annotations that would otherwise overlap). Further, the annotation unit 138 may allow annotations in the first annotation format to occlude annotations in a second annotation format (e.g., two-dimensional annotations as discussed above). In some implementations, if two annotation in the second annotation format overlap, the annotation unit 138 prioritizes the annotation of the street closer to the user/device 104, by causing that annotation to overlap the annotation of the street from the user/device 104.

Additionally or alternatively, in some implementations, the annotation unit 138 merges the annotations for streets if those annotations would otherwise overlap, and if the names of the streets are sufficiently similar to make this possible. For example, the annotation unit 138 may merge the annotations “E 32nd Street” and “W 32nd Street” into the single annotation “32nd Street” if the former two annotations would overlap.

Additionally or alternatively, in some implementations, the annotation unit 138 filters out or otherwise precludes annotations for streets that are occluded by buildings and/or other structures. For example, the VPS 134 may associate portions of the user's current real-world view with a 3D geometry (in the 3D model) of a building or other structure, and determine, based on the 3D geometry, the position of one or more streets, and the direction of user's field of view, whether the street(s) is/are occluded by the building/structure. If so (or in some implementations, if the street(s) is/are occluded to at least some threshold degree), the annotation unit 138 precludes annotation of the occluded street(s).

Additionally or alternatively, in some implementations, the annotation unit 138 adjusts the positions of annotations relative to the positions that would result from the points in the street mesh 162 in the 3D model of the environment. For example, the map/navigation application 130 may detect that a 2D plane depicted in images from a camera of the sensors 129 is offset slightly from a corresponding 2D plane in the 3D model, and adjust the position of the annotation (e.g., raise or lower the annotation on the display 124) to cause the annotation to align with the 2D plane detected from the camera images rather than the 2D plane of the 3D model.

Additionally or alternatively, in some implementations, the annotation unit 138 (or the map/navigation application 130 more generally) permits place (e.g., POI) annotations and/or pins to occlude street annotations, irrespective of the annotation format.

Additionally or alternatively, in some implementations, the annotation unit 138 (or the map/navigation application 130 more generally) precludes street annotations (of any format) from occluding orientation and/or navigation cues, and vice-versa.

In some implementations, the map/navigation application 130 supports one or more user interactions with the augmented reality user interface. For example, the map/navigation application 130 may detect when a user hovers/lingers (leaves his or her fingertip) on the display 124 (if a touchscreen), and in response highlight the entire street mesh. Alternatively, the map/navigation application 130 may respond by only highlighting the portion of the street mesh corresponding to the particular street that the user is touching on the display 124.

Additionally or alternatively, in some implementations, the map/navigation application 130 may detect when a user hovers/lingers (leaves his or her fingertip) on a particular three-dimensional annotation on the display 124 (if a touchscreen), and in response cause the annotation to rotate or “fish-tail” such that the characters of the annotation are more orthogonal to the user's line of view. This may be useful, for example, when a particular annotation is too in-line with the user's line of view and therefore difficult to read. In some implementations, the map/navigation application 130 will only cause up to some maximum amount of correction or rotation (e.g., up to 30 degrees rotation), to ensure that the annotation does not move so much as to cause the user to think that it is associated with a different street in the first-person perspective view.

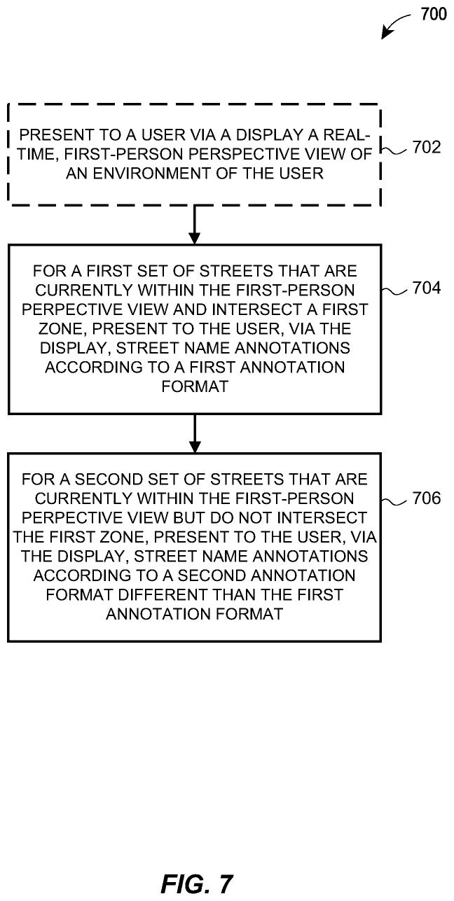

Example methods of annotating streets to facilitate navigation (e.g., for a pedestrian) will now be discussed with reference to FIGS. 7-9. The method or any one or more of the methods of FIGS. 7-9 may be implemented as instructions stored on one or more computer-readable media and executed on one or more processors in one or more computing devices. For example, the method(s) may be implemented by the processing unit 120 of the mobile communications device 104 in FIG. 1, when executing instructions of the map/navigation application 130.

Referring first to the method 700 of FIG. 7, a real-time, first-person perspective view of an environment of a user is presented to the user via a display (e.g., display 124) at block 702. The first-person perspective view may be provided by camera image frames (e.g., captured by one or more cameras of the sensors 129). In some implementations, the camera image frames are captured but block 702 is omitted (i.e., the camera images are not presented to the user). For example, if the method 700 is implemented by a processing unit of smart glasses, the real-time, first-person perspective view of the environment of the user may instead be visible to the user through the display (e.g., if the display includes one or more transparent lenses with integrated electronic components).

At block 704, for a first set of one or more streets that are currently within the first-person perspective view and intersect a first zone, street name annotations are presented to the user via the display and according to a first annotation format. The first zone is defined based on distance from the user. For example, the first zone may be the area within a fixed radius around the user's mobile communications device (e.g., zone 302 of FIG. 3), or may be dynamically set (e.g., by the map/navigation application 130). The first annotation format may be a three-dimensional format (e.g., with annotation characters in an upright position relative to the ground of the environment in the first-person perspective view, and in alignment with directions of corresponding streets in the first-person perspective view, such as shown in FIG. 2 for annotations 202, 204, 206), for example.

At block 706, for a second set of one or more streets that are currently within the first-person perspective view and do not intersect the first zone (e.g., do not intersect the first zone at any point, or do not intersect the first zone within the first-person perspective view), one or more street name annotations are presented to the user via the display and according to a second annotation format that is different than the first annotation format. The second annotation format may be a two-dimensional format, for example.

In some implementations, the method 700 also includes determining that each street in the first set of streets intersects the first zone, and determining that each street in the second streets intersects a second zone surrounding the first zone, does not intersect the first zone, and intersects at least one street of the first set of streets. Block 704 may then occur in response to determining that each street in the first set of streets intersects the first zone, and block 706 may occur in response to determining that each street in the second streets intersects the second zone, does not intersect the first zone, and intersects at least one street of the first set of streets. In other implementations, the second set of streets need not intersect any street of the first set of streets. The second zone, like the first zone, may be defined based on distance from the user (e.g., defined as the area within a larger radius around the user/device, as with zone 304 of FIG. 3). As noted above in connection with FIG. 4A, determining that a given street of the second set of streets does not intersect the first zone may include determining that the given street does not intersect any portion of the first zone, or may include determining only that the given street does not intersect any portion of the first zone that is currently within the first-person perspective view (irrespective of whether the street intersects any out-of-view portion of the first zone).

Further, in some implementations, the method 700 may include determining that each street in a third set of one or more streets intersects a third zone (e.g., zone 306) surrounding the second zone, but not the second zone (and thus, not the first zone). The method may further include, in response to that determination, precluding annotation of the third set of streets irrespective of whether any street of the third set of streets is currently within the first-person perspective view. As noted above in connection with FIG. 4A, determining that a given street of the third set of streets does not intersect the second zone may include determining that the given street does not intersect any portion of the second zone, or may include determining only that the given street does not intersect any portion of the second zone that is currently within the first-person perspective view (irrespective of whether the street intersects any out-of-view portion of the second zone).

In some implementations, the method 700 also includes the method 800, discussed below.

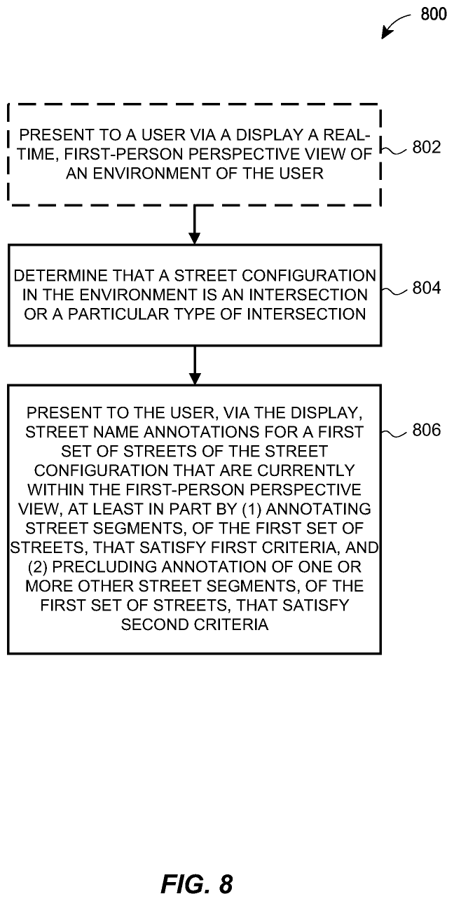

Referring next to the method 800 of FIG. 8, a real-time, first-person perspective view of an environment of a user is presented to the user via a display (e.g., display 124) at block 802. The first-person perspective view may be provided by camera image frames (e.g., captured by one or more cameras of the sensors 129). In some implementations, the camera image frames are captured but block 802 is omitted (i.e., the camera images are not presented to the user). For example, if the method 800 is implemented by a processing unit of smart glasses, the real-time, first-person perspective view of the environment of the user may instead be visible to the user through the display (e.g., if the display includes one or more transparent lenses with integrated electronic components).

At block 804, it is determined that a street configuration in the user's environment is an intersection, or a particular type of intersection (e.g., an intersection cluster with internal and external street segments). Various exemplary (but non-limiting) criteria for determining that a street configuration is an intersection cluster are discussed above with reference to FIG. 5.

At block 806, in response to the determination at block 804, street name annotations for a first set of one or more streets of the street configuration that are currently within the first-person perspective view are presented to the user via the display. Block 806 includes annotating one or more street segments, of the first set of streets, that satisfy one or more first criteria. Block 806 further includes precluding annotation of one or more other street segments, of the first set of streets, that satisfy one or more second criteria, irrespective of whether any street segment of the one or more other street segments is currently within the first-person perspective view. In some implementations, block 806 includes positioning each street name annotation for the first set of streets on a side of the (complex) intersection, in the first person perspective view, that is closest to the user. Additionally or alternatively, in some implementations, block 806 includes, when a given street maintains a same street name across the intersection, omitting any street name annotation for the given street on the side of the intersection, in the first-person perspective view, that is further from the user, and, when the given street changes a street name across the intersection, positioning an additional street name annotation for the given street on the side of the intersection, in the first-person perspective view, that is further from the user.

In some implementations, the one or more first criteria include a criterion that a street segment of an intersection cluster is only annotated if the segment is an external segment, and the one or more second criteria include a criterion that a street segment is not annotated (irrespective of whether the segment is currently within the first-person perspective view) if the segment is an internal segment, e.g., as discussed above with reference to FIGS. 5, 6A, and 6B.

In some implementations, the method 800 also includes the method 700 discussed above and/or the method 900 discussed below.

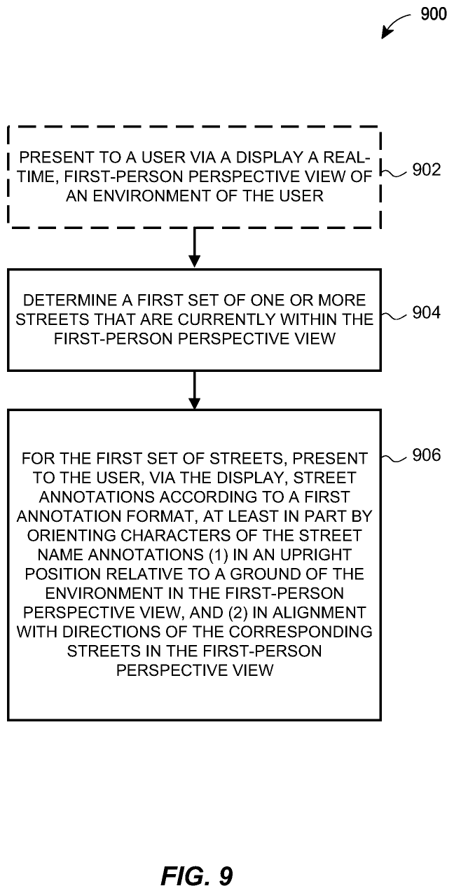

Referring next to the method 900 of FIG. 9, a real-time, first-person perspective view of an environment of a user is presented to the user via a display (e.g., display 124) at block 902. The first-person perspective view may be provided by camera image frames (e.g., captured by one or more cameras of the sensors 129). In some implementations, the camera image frames are captured but block 902 is omitted (i.e., the camera images are not presented to the user). For example, if the method 900 is implemented by a processing unit of smart glasses, the real-time, first-person perspective view of the environment of the user may instead be visible to the user through the display (e.g., if the display includes one or more transparent lenses with integrated electronic components).

At block 904, a first set of one or more streets that are currently within the first-person perspective view is determined. Block 904 may be performed by the VPS 134, by processing camera images and IMU data from the sensors 129 and correlating the first-person perspective view with elements of a 3D model of the environment, for example.

At block 906, for the first set of streets currently within the first-person perspective view, one or more street name annotations are presented to the user via the display and according to a first annotation format. Block 904 includes orienting characters of the street name annotations in a three-dimensional manner (i.e., in an upright position relative to a ground of the environment in the first-person perspective view, and in alignment with directions of the corresponding streets in the first-person perspective view, such as is shown in FIG. 2 for annotations 202, 204, 206). In some implementations, block 904 includes positioning each of the street name annotations for the first set of streets on a segment of the corresponding street that is a shortest distance from the user.

In some implementations, the method 900 also includes the method 700 and/or the method 800 discussed above.

Although the foregoing text sets forth a detailed description of numerous different aspects and implementations of the invention, it should be understood that the scope of the patent is defined by the words of the claims set forth at the end of this patent. The detailed description is to be construed as exemplary only and does not describe every possible implementation because describing every possible implementation would be impractical, if not impossible. Numerous alternative implementations could be implemented, using either current technology or technology developed after the filing date of this patent, which would still fall within the scope of the claims. The disclosure herein contemplates at least the following examples:

Example 1. A method of annotating streets to facilitate navigation, the method comprising: for a first set of one or more streets that (i) are currently within a real-time, first-person perspective view of an environment of a user and (ii) intersect a first zone, presenting to the user via a display, by one or more processors, street name annotations according to a first annotation format, wherein the first zone is defined based on distance from the user; and for a second set of one or more streets that are currently within the first-person perspective view but do not intersect the first zone, presenting to the user via the display, by the one or more processors, street name annotations according to a second annotation format different than the first annotation format.

Example 2. The method of example 1, wherein: presenting the street name annotations for the first set of streets according to the first annotation format includes presenting three-dimensional street name annotations on the first-person perspective view of the environment; and presenting the street name annotations for the second set of streets according to the second annotation format includes presenting two-dimensional street name annotations on the first-person perspective view of the environment.

Example 3. The method of example 1 or 2, wherein presenting the street name annotations for the first set of streets according to the first annotation format includes orienting characters of the street name annotations (i) in an upright position relative to a ground of the environment in the first-person perspective view, and (ii) in alignment with directions of corresponding streets in the first-person perspective view.

Example 4. The method of any one of examples 1-3, further comprising, before presenting the street name annotations for the first set of streets according to the first annotation format and before presenting the street name annotations for the second set of streets according to the second annotation format: determining, by the one or more processors, that each street in the first set of streets intersects the first zone; and determining, by the one or more processors, that each street in the second set of streets intersects a second zone surrounding the first zone, does not intersect the first zone, and intersects at least one street of the first set of streets, wherein presenting the street name annotations for the first set of streets according to the first annotation format is in response to determining that each street in the first set of streets intersects the first zone, and wherein presenting the street name annotations for the second set of streets according to the second annotation format is in response to determining that each street in the second set of streets intersects the second zone, does not intersect the first zone, and intersects at least one street of the first set of streets.

Example 5. The method of example 4, further comprising: determining, by the one or more processors, that each street in a third set of one or more streets intersects a third zone surrounding the second zone and does not intersect the second zone; and precluding, by the one or more processors, annotation of the third set of streets irrespective of whether any street of the third set of streets is currently within the first-person perspective view.

Example 6. The method of any one of examples 1-5, further comprising: determining, by the one or more processors, that a street configuration in the first zone is an intersection of at least a first street and a second street, wherein presenting the street name annotations for the first set of streets according to the first annotation format includes, in response to determining that the street configuration is an intersection, positioning the street name annotations corresponding to the first street and the second street on sides of the intersection, in the first-person perspective view, that are closest to the user.

Example 7. The method of example 6, wherein presenting the street name annotations for the first set of streets according to the first annotation format further includes: for each street that maintains a same street name across the intersection, precluding annotation of the street on a side of the intersection, in the first-person perspective view, that is further from the user, irrespective of whether the side of the intersection further from the user is currently within the first-person perspective view; and for each street that changes a street name across the intersection, positioning an additional street name annotation for the street on a side of the intersection, in the first-person perspective view, that is further from the user.

Example 8. The method of any one of examples 1-7, further comprising: determining, by the one or more processors, that a street configuration in the first zone is an intersection cluster having internal and external street segments, wherein presenting the street name annotations for the first set of streets according to the first annotation format includes, in response to determining that the street configuration is an intersection cluster, annotating the external street segments while precluding annotation of the internal street segments, irrespective of whether any street segment of the internal street segments is currently within the first-person perspective view.

Example 9. The method of any one of examples 1-8, wherein the first zone is defined as an area within a fixed radius around the user.

Example 10. A method of annotating streets to facilitate navigation of intersections, the method comprising: determining, by one or more processors, that a street configuration in an environment of a user is an intersection or a particular type of intersection; and presenting to the user via a display, by the one or more processors and in response to the determining, street name annotations for a first set of one or more streets of the street configuration that are currently within a real-time, first-person perspective view of the user, wherein presenting the street name annotations includes: (i) annotating one or more street segments, of the first set of streets, that satisfy one or more first criteria; and (ii) precluding annotation of one or more other street segments, of the first set of streets, that satisfy one or more second criteria, irrespective of whether any street segment of the one or more other street segments is currently within the first-person perspective view.

Example 11. The method of example 10, wherein the determining includes: determining that the street configuration is an intersection cluster having internal and external street segments.

Example 12. The method of example 11, wherein: annotating the one or more street segments that satisfy the one or more first criteria includes annotating external street segments of the first set of streets; and precluding annotation of one or more other street segments that satisfy the one or more second criteria includes precluding annotation of internal street segments of the first set of streets.

Example 13. The method of any one of examples 10-12, wherein presenting the street name annotations for the first set of streets includes positioning each of the street name annotations on a side of the intersection, in the first-person perspective view, that is closest to the user.

Example 14. The method of example 13, wherein presenting the street name annotations for the first set of streets further includes: when a given street maintains a same street name across the intersection, omitting any street name annotation for the given street on a side of the intersection, in the first-person perspective view, that is further from the user; and when the given street changes a street name across the intersection, positioning an additional street name annotation for the given street on a side of the intersection, in the first-person perspective view, that is further from the user.

Example 15. The method of any one of examples 10-14, wherein the first set of streets intersects a first zone defined based on distance from the user, wherein presenting the street name annotations for the first set of streets is according to a first annotation format, and wherein the method further comprises: for a second set of one or more streets that are currently within the first-person perspective view but do not intersect the first zone, presenting to the user via the display, by the one or more processors, street name annotations according to a second annotation format different than the first annotation format.

Example 16. The method of example 15, wherein: presenting the street name annotations for the first set of streets according to the first annotation format includes presenting three-dimensional street name annotations on the first-person perspective view of the environment; and presenting the street name annotations for the second set of streets according to the second annotation format includes presenting two-dimensional street name annotations on the first-person perspective view of the environment.

Example 17. The method of example 15 or 16, wherein presenting the street name annotations for the first set of streets according to the first annotation format includes orienting characters of the street name annotations (i) in an upright position relative to a ground of the environment in the first-person perspective view, and (ii) in alignment with directions of corresponding streets in the first-person perspective view.

Example 18. The method of any one of examples 15-17, further comprising, before presenting the street name annotations for the first set of streets according to the first annotation format and before presenting the street name annotations for the second set of streets according to the second annotation format: determining, by the one or more processors, that each street in the first set of streets intersects the first zone; and determining, by the one or more processors, that each street in the second set of streets intersects a second zone surrounding the first zone, does not intersect the first zone, and intersects at least one street of the first set of streets, wherein presenting the street name annotations for the first set of streets according to the first annotation format is in response to determining that each street in the first set of streets intersects the first zone, and wherein presenting the street name annotations for the second set of streets according to the second annotation format is in response to determining that each street in the second set of streets intersects the second zone, does not intersect the first zone, and intersects at least one street of the first set of streets.

Example 19. The method of example 18, further comprising: determining, by the one or more processors, that each street in a third set of one or more streets intersects a third zone surrounding the second zone and does not intersect the second zone; and precluding, by the one or more processors, annotation of the third set of streets irrespective of whether any street of the third set of streets is currently within the first-person perspective view.

Example 20. The method of any one of examples 15-19, wherein the first zone is defined as an area within a fixed radius around the user.

Example 21. A method of annotating streets to facilitate navigation, the method comprising: determining, by one or more processors, a first set of one or more streets that are currently within a real-time, first-person perspective view of an environment of a user; for the first set of streets, presenting to the user, via a display and by the one or more processors, one or more street name annotations according to a first annotation format, wherein presenting the street name annotations for the first set of streets according to the first annotation format includes orienting characters of the street name annotations (i) in an upright position relative to a ground of the environment in the first-person perspective view, and (ii) in alignment with directions of the corresponding streets in the first-person perspective view.

Example 22. The method of example 21, wherein presenting the street name annotations for the first set of streets according to the first annotation format includes positioning each of the street name annotations for the first set of streets on a segment of the corresponding street that is a shortest distance from the user.

Example 23. The method of example 21 or 22, wherein each street of the first set of streets intersects a first zone defined based on distance from the user, and wherein the method further comprises: for a second set of one or more streets that are currently within the first-person perspective view but do not intersect the first zone, presenting to the user, via the display and by the one or more processors, one or more street name annotations according to a second annotation format different than the first annotation format.

Example 24. The method of example 23, wherein determining the first set of streets includes determining that each street in the first set of streets intersects the first zone; wherein the method further comprises determining, by the one or more processors, that each street in the second set of streets intersects a second zone surrounding the first zone, does not intersect the first zone, and intersects at least one street of the first set of streets; wherein presenting the street name annotations for the first set of streets according to the first annotation format is in response to determining that each street in the first set of streets intersects the first zone; and wherein presenting the street name annotations for the second set of streets according to the second annotation format is in response to determining that each street in the second set of streets intersects the second zone, does not intersect the first zone, and intersects at least one street of the first set of streets.

Example 25. The method of example 23, further comprising: determining, by the one or more processors, that each street in a third set of one or more streets intersects a third zone surrounding the second zone and does not intersect the second zone; and precluding, by the one or more processors, annotation of the third set of streets irrespective of whether any street of the third set of streets is currently within the first-person perspective view.

Example 26. The method of any one of examples 21-25, further comprising: determining, by the one or more processors, that a street configuration comprising the first set of streets is an intersection of at least a first street and a second street, wherein presenting the street name annotations for the first set of streets according to the first annotation format includes, in response to determining that the street configuration is an intersection, positioning the street name annotations corresponding to the first street and the second street on sides of the intersection, in the first-person perspective view, that are closest to the user.

Example 27. The method of example 26, wherein presenting the street name annotations for the first set of streets according to the first annotation format further includes: for each street that maintains a same street name across the intersection, precluding annotation of the street on a side of the intersection, in the first-person perspective view, that is further from the user, irrespective of whether the side of the intersection further from the user is currently within the first-person perspective view; and for each street that changes a street name across the intersection, positioning an additional street name annotation for the street on a side of the intersection, in the first-person perspective view, that is further from the user.

Example 28. The method of any one of examples 21-27, further comprising: determining, by the one or more processors, that a street configuration comprising the first set of streets is an intersection cluster having internal and external street segments, wherein presenting the street name annotations for the first set of streets according to the first annotation format includes, in response to determining that the street configuration is an intersection cluster, annotating the external street segments while precluding annotation of the internal street segments, irrespective of whether any street segment of the internal street segments is currently within the first-person perspective view.

Example 29. The method of any one of examples 21-28, wherein the first zone is defined as an area within a fixed radius around the user.

Example 30. The method of any one of examples 1-29, wherein: the display is a smartphone display; and the method further comprises presenting to the user, via the smartphone display, camera images of the real-time, first-person perspective view of the environment.

Example 31. The method of any one of examples 1-29, wherein: the display comprises one or more lenses of smart glasses with integrated electronic components.

Example 32. A computing device configured to implement the method of any one of examples 1-31.

Example 33. One or more non-transitory, computer-readable media storing instructions that, when executed by one or more processors, cause the one or more processors to implement the method of any one of examples 1-31.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Unless specifically stated otherwise, discussions in the present disclosure using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one implementation” or “an implementation” means that a particular element, feature, structure, or characteristic described in connection with the implementation is included in at least one implementation or implementation. The appearances of the phrase “in one implementation” in various places in the specification are not necessarily all referring to the same implementation.

As used in the present disclosure, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for facilitating navigation through the disclosed principles in the present disclosure. Thus, while particular implementations and applications have been illustrated and described, it is to be understood that the disclosed implementations are not limited to the precise construction and components disclosed in the present disclosure. Various modifications, changes and variations, which will be apparent to those skilled in the art, may be made in the arrangement, operation and details of the method and apparatus disclosed in the present disclosure without departing from the spirit and scope defined in the appended claims.

1. A method of annotating streets to facilitate navigation, the method comprising:
for a first set of one or more streets that (i) are currently within a real-time, first-person perspective view of an environment of a user and (ii) intersect a first zone, presenting to the user via a display, by one or more processors, street name annotations according to a first annotation format, wherein the first zone is defined based on distance from the user; and
for a second set of one or more streets that are currently within the first-person perspective view but do not intersect the first zone, presenting to the user via the display, by the one or more processors, street name annotations according to a second annotation format different than the first annotation format.

2. The method of claim 1, wherein:
presenting the street name annotations for the first set of streets according to the first annotation format includes presenting three-dimensional street name annotations on the first-person perspective view of the environment; and
presenting the street name annotations for the second set of streets according to the second annotation format includes presenting two-dimensional street name annotations on the first-person perspective view of the environment.

3. The method of claim 1, wherein presenting the street name annotations for the first set of streets according to the first annotation format includes orienting characters of the street name annotations (i) in an upright position relative to a ground of the environment in the first-person perspective view, and (ii) in alignment with directions of corresponding streets in the first-person perspective view.

4. The method of claim 1, further comprising, before presenting the street name annotations for the first set of streets according to the first annotation format and before presenting the street name annotations for the second set of streets according to the second annotation format:
determining, by the one or more processors, that each street in the first set of streets intersects the first zone; and
determining, by the one or more processors, that each street in the second set of streets intersects a second zone surrounding the first zone, does not intersect the first zone, and intersects at least one street of the first set of streets,
wherein presenting the street name annotations for the first set of streets according to the first annotation format is in response to determining that each street in the first set of streets intersects the first zone, and
wherein presenting the street name annotations for the second set of streets according to the second annotation format is in response to determining that each street in the second set of streets intersects the second zone, does not intersect the first zone, and intersects at least one street of the first set of streets.

5. The method of claim 4, further comprising:
determining, by the one or more processors, that each street in a third set of one or more streets intersects a third zone surrounding the second zone and does not intersect the second zone; and
precluding, by the one or more processors, annotation of the third set of streets irrespective of whether any street of the third set of streets is currently within the first-person perspective view.

6. The method of claim 1, further comprising:
determining, by the one or more processors, that a street configuration in the first zone is an intersection of at least a first street and a second street,
wherein presenting the street name annotations for the first set of streets according to the first annotation format includes, in response to determining that the street configuration is an intersection, positioning the street name annotations corresponding to the first street and the second street on sides of the intersection, in the first-person perspective view, that are closest to the user.

7. The method of claim 6, wherein presenting the street name annotations for the first set of streets according to the first annotation format further includes:
for each street that maintains a same street name across the intersection, precluding annotation of the street on a side of the intersection, in the first-person perspective view, that is further from the user, irrespective of whether the side of the intersection further from the user is currently within the first-person perspective view; and
for each street that changes a street name across the intersection, positioning an additional street name annotation for the street on a side of the intersection, in the first-person perspective view, that is further from the user.

8. The method of claim 1, further comprising:
determining, by the one or more processors, that a street configuration in the first zone is an intersection cluster having internal and external street segments,
wherein presenting the street name annotations for the first set of streets according to the first annotation format includes, in response to determining that the street configuration is an intersection cluster, annotating the external street segments while precluding annotation of the internal street segments, irrespective of whether any street segment of the internal street segments is currently within the first-person perspective view.

9. The method of claim 1, wherein the first zone is defined as an area within a fixed radius around the user.

10. A method of annotating streets to facilitate navigation of intersections, the method comprising:
determining, by one or more processors, that a street configuration in an environment of a user is an intersection or a particular type of intersection; and
presenting to the user via a display, by the one or more processors and in response to the determining, street name annotations for a first set of one or more streets of the street configuration that are currently within a real-time, first-person perspective view of the user, wherein presenting the street name annotations includes:
(i) annotating one or more street segments, of the first set of streets, that satisfy one or more first criteria; and
(ii) precluding annotation of one or more other street segments, of the first set of streets, that satisfy one or more second criteria, irrespective of whether any street segment of the one or more other street segments is currently within the first-person perspective view.

11. The method of claim 10, wherein the determining includes:
determining that the street configuration is an intersection cluster having internal and external street segments.

12. The method of claim 11, wherein:
annotating the one or more street segments that satisfy the one or more first criteria includes annotating external street segments of the first set of streets; and
precluding annotation of one or more other street segments that satisfy the one or more second criteria includes precluding annotation of internal street segments of the first set of streets.

13. The method of method of claim 10, wherein presenting the street name annotations for the first set of streets includes positioning each of the street name annotations on a side of the intersection, in the first-person perspective view, that is closest to the user.

14. The method of claim 13, wherein presenting the street name annotations for the first set of streets further includes:
when a given street maintains a same street name across the intersection, omitting any street name annotation for the given street on a side of the intersection, in the first-person perspective view, that is further from the user; and
when the given street changes a street name across the intersection, positioning an additional street name annotation for the given street on a side of the intersection, in the first-person perspective view, that is further from the user.

15. The method of claim 10, wherein the first set of streets intersects a first zone defined based on distance from the user, wherein presenting the street name annotations for the first set of streets is according to a first annotation format, and wherein the method further comprises:
for a second set of one or more streets that are currently within the first-person perspective view but do not intersect the first zone, presenting to the user via the display, by the one or more processors, street name annotations according to a second annotation format different than the first annotation format.

16. The method of claim 15, wherein:
presenting the street name annotations for the first set of streets according to the first annotation format includes presenting three-dimensional street name annotations on the first-person perspective view of the environment; and
presenting the street name annotations for the second set of streets according to the second annotation format includes presenting two-dimensional street name annotations on the first-person perspective view of the environment.

17. The method of claim 15, wherein presenting the street name annotations for the first set of streets according to the first annotation format includes orienting characters of the street name annotations (i) in an upright position relative to a ground of the environment in the first-person perspective view, and (ii) in alignment with directions of corresponding streets in the first-person perspective view.

18. The method of claim 15, further comprising, before presenting the street name annotations for the first set of streets according to the first annotation format and before presenting the street name annotations for the second set of streets according to the second annotation format:
determining, by the one or more processors, that each street in the first set of streets intersects the first zone; and
determining, by the one or more processors, that each street in the second set of streets intersects a second zone surrounding the first zone, does not intersect the first zone, and intersects at least one street of the first set of streets,
wherein presenting the street name annotations for the first set of streets according to the first annotation format is in response to determining that each street in the first set of streets intersects the first zone, and
wherein presenting the street name annotations for the second set of streets according to the second annotation format is in response to determining that each street in the second set of streets intersects the second zone, does not intersect the first zone, and intersects at least one street of the first set of streets.

19. The method of claim 18, further comprising:
determining, by the one or more processors, that each street in a third set of one or more streets intersects a third zone surrounding the second zone and does not intersect the second zone; and
precluding, by the one or more processors, annotation of the third set of streets irrespective of whether any street of the third set of streets is currently within the first-person perspective view.

20. (canceled)

21. A method of annotating streets to facilitate navigation, the method comprising:
determining, by one or more processors, a first set of one or more streets that are currently within a real-time, first-person perspective view of an environment of a user;
for the first set of streets, presenting to the user, via a display and by the one or more processors, one or more street name annotations according to a first annotation format, wherein presenting the street name annotations for the first set of streets according to the first annotation format includes orienting characters of the street name annotations (i) in an upright position relative to a ground of the environment in the first-person perspective view, and (ii) in alignment with directions of the corresponding streets in the first-person perspective view.

22-33. (canceled)
